(19) United States
(12) Patent Application Publication
(10) Pub. No.: US 2009/0084656 A1
(43) Pub. Date: Apr. 2, 2009

(54) System for treating money in an automatic vending machine

(75) Inventor: Yoshikazu Ishiwata, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Kabushiki-Kaisya I-S ELECTRONICS, Tokyo (JP); Kabushiki-Kaisya FUJIDENKISHOKAI, Yokohama-shi (JP)

(21) Appl. No.: 11/904,658

(22) Filed: Sep. 28, 2007

(51) Int. Cl. G07F 9/00

(52) U.S. Cl. 194/215

(57) ABSTRACT

A system for treating money in an automatic vending machine imposes a limitation on the kinds of bills (amount of money) and on the number of pieces of bills that are to be thrown in due to the program of the controller in the automatic vending machine, making it often difficult to cope with the use of various kinds of moneys, lowering the utilization of the automatic vending machines and decreasing the profit. To overcome the above problem, a device for treating the coins that are thrown in is electrically connected to communication means which receives and transmits data related to the throw-in of coins, and the communication means, the device for identifying the bills that are thrown in and the controller in the automatic vending machine are electrically connected together. Further, the primary side and the secondary side of the communication means select either a VTS system or a MDB system and, particularly, the primary side is of the VTS system and the secondary side is of the MDB system. The controller is equipped with a change-over switch for changing the price of a good to be sold and for freely setting the kinds of bills that can be used, the number of pieces thereof and a combination thereof, and a change is discharged within a range set by the device for treating the coins.

### BACKGROUND OF THE INVENTION

1. Field of the Invention

This invention relates to a system for treating money in an automatic vending machine and, particularly, to a system for treating money in an automatic vending machine employing a VTS system or an MDB system.

2. Description of the Related Art

In the conventional systems for treating money in the automatic vending machines of the VTS system and the MDB system, a device for identifying the bills thrown into a controller in the automatic vending machine and a device for treating the coins are electrically connected together, and data related to the throw-in of money from these devices are sent to the controller to indicate the sum of moneys that are thrown in.

In the device for identifying the bills in the conventional systems for treating money, the kinds and amounts of bills that can be thrown in are limited by a maximum value or a minimum value, and the bills that are thrown in within the limitation are just held at that position or stay in the device for identifying the bills until there is an input from a purchase switch or from a refund switch, prohibiting the throw in of any additional money. In the system which is desired to permit the bills only to be thrown in, too, the throw-in of bills is prohibited in case the device for treating the coins is out of coins for change.

In the conventional systems for treating money in the automatic vending machines as described above, bills to be thrown in are, in many cases, limited by the upper limit or lower limit of the kind of money (amount of money) making it difficult to meet a variety of requests. This lowers the frequency of use of the automatic vending machines that are installed.
[Patent document 1] JP-A-2007-87107

### SUMMARY OF THE INVENTION

The present invention solves the problem in that a system for treating money in an automatic vending machine imposes a limitation on the kinds of bills (amount of money) and on the number of pieces of bills that can be thrown in due to the program of the controller in the automatic vending machine, making it often difficult to cope with the use of various kinds of moneys, lowering the utilization of the automatic vending machines and decreasing the profit.

In order to solve the above problem, a first aspect of the present invention deals with a system for treating money in an automatic vending machine wherein a device for identifying the bills that are thrown in is electrically connected to a controller in the automatic vending machine, the device for identifying the bills is electrically connected to communication means which receives and transmits the data related to the throw-in of coins, and the communication means is electrically connected to the controller in the automatic vending machine.

A second aspect of the present invention further deals with a system for treating money in an automatic vending machine wherein a device for identifying the bills that are thrown in is electrically connected to a controller in the automatic vending machine, a device for treating the coins that are thrown in is electrically connected to communication means which receives and transmits data related to the throw-in of coins, and the communication means is electrically connected to the controller in the automatic vending machine.

A third aspect of the present invention further deals with a system for treating money in an automatic vending machine wherein a device for treating the coins that are thrown in is electrically connected to communication means which receives and transmits data related to the throw-in of coins, and the communication means, the device for identifying the bills that are thrown in and the controller in the automatic vending machine are electrically connected together.

A fourth aspect and a fifth aspect of the present invention further deal with a system for treating money in an automatic vending machine wherein the primary side and the secondary side of the communication means select either a VTS (vivid transaction system) system or the MDB (multi-drop bus) system and, particularly, the primary side is of the VTS system and the secondary side is of the MDB system, and wherein the controller is equipped with a change-over switch for changing the price of a good to be sold and for freely setting the kinds of bills that can be used, the number of pieces thereof and a combination thereof, and a change is discharged within a range set by the device for treating the coins.

According to the first aspect of the invention, the system for treating money that imposes limitation on the maximum amount of money of the bill permits the communication means that receives and transmits the data of throw-in of coins to transmit the data of throw-in of bills as data of throw-in of coins to the controller of the automatic vending machine, making it possible to throw in the bills up to a maximum limit amount of coins that can be thrown in as permitted by the controller of the automatic vending machine.

According to the first aspect of the invention, further, the communication mean can be so controlled as to avoid the data related to run-out of the change and, besides, the conventional device for treating the coins can be omitted (discharges no change).

Next, according to the second aspect of the invention, even when a bill of an amount of money smaller than a minimum amount of money of a bill that can be thrown in is used, the system for treating money that imposes limitation on the minimum amount of money of the bill calculates a magnification which is not smaller than the minimum amount of money, and transmits it to the controller in the automatic vending machine. Conversely, therefore, the refund data issued from the controller is transmitted as a fraction of the magnification to the device for treating the coins. Therefore, the change at the time of purchasing the good or the refund of when no good is purchased is smoothly discharged even if the amounts of money are those out of the limited range.

According to the second aspect of the invention, the above treatment is executed without particularly changing the control program of the automatic vending machine or changing the control program of the device for treating the coins.

According to the third aspect of the invention, the system for treating money that imposes limitation on the minimum amount of money of the bill converts the data into the data of throw-in of the device for treating the coins through the communication means if a bill of an amount of money smaller than the limited amount of money is thrown in, and transmits the data of throw-in of ordinary bills to the controller when a bill of an amount of money larger than the limited amount of money is thrown in. Further, when the bill is thrown in to purchase the good and the amount of money to be refunded is equal to or greater than the amount of money of the bill that is thrown in, the communication means works to refund the coin equal to the amount of difference from the bill.

According to the third aspect of the invention, the above treatment is executed without particularly changing the control program of the automatic vending machine or changing the control program of the device for treating the coins.

According to the fourth aspect of the invention, the VTS system and the MDB system can be used in a multiplicity of ways with the communication means as a boundary, and can be widely applied to the regions without receiving limitation depending upon the communication systems. According to the fifth aspect of the invention, a wide range of goods can be set for the purpose of sale, and the kinds of money that can be used can be freely set depending upon the prices, offering more convenience for use.

### BRIEF DESCRIPTION OF THE DRAWINGS

FIG. 1 is a block diagram illustrating a first embodiment of the invention;

FIG. 2 is a flowchart illustrating a program of a device for identifying the bills;

FIG. 3 is a flowchart illustrating a program of communication means;

FIG. 4 is a block diagram illustrating a second embodiment of the invention;

FIG. 5 is a flowchart illustrating a program of a device for identifying the bills;

FIG. 6 is a flowchart illustrating a program of communication means;

FIG. 7 is a block diagram illustrating a third embodiment of the invention;

FIG. 8 is a flowchart illustrating a program of a device for identifying the bills; and

FIG. 9 is a flowchart illustrating a program of communication means.

### DESCRIPTION OF THE PREFERRED EMBODIMENTS

A system for treating money in an automatic vending machine according to the present invention is achieved, constituted as following embodiments shown in drawings.

### Embodiment 1

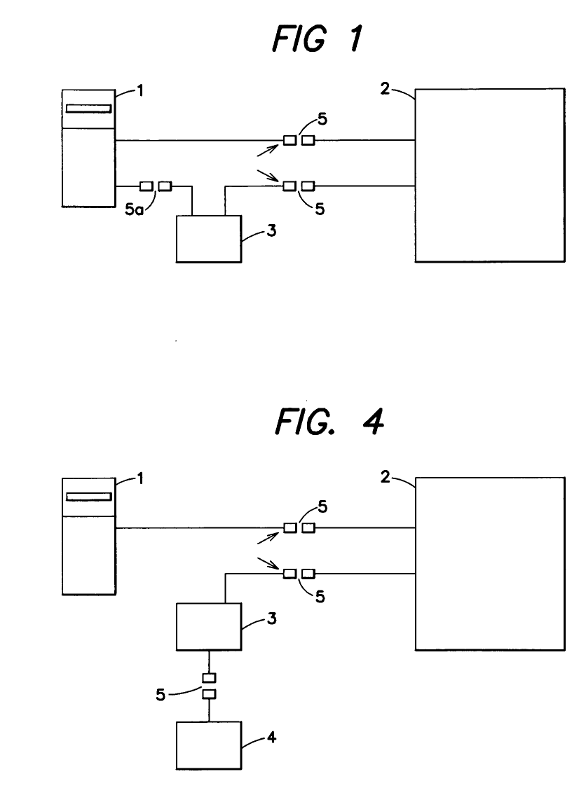

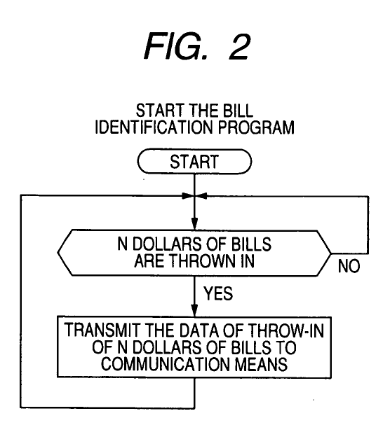

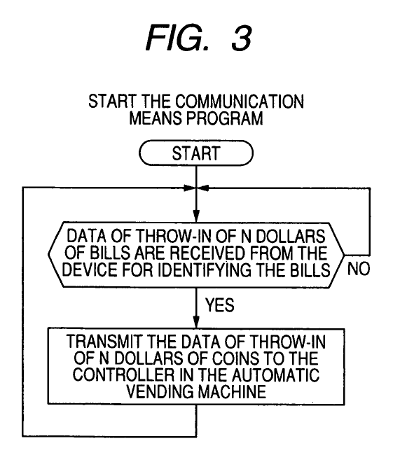

Next, a first embodiment of the invention will be described with reference to FIGS. 1 to 3. FIG. 1 is a block diagram illustrating a first embodiment of the invention, FIG. 2 is a flowchart illustrating a program of a device for identifying the bills, and FIG. 3 is a flowchart illustrating a program of communication means.

In these drawings, reference numeral 1 denotes a device for identifying the bills. The device 1 for identifying the bills is, usually, mounted on the inner surface of a front door of an automatic vending machine. A port for throwing the bills in is opened outward through the front door, enabling the bills to be thrown in. Reference numeral 2 denotes a controller in the automatic vending machine. The controller 2 is electrically connected to the device 1 for identifying the bills through a communication circuit of a VTS system, and those data related to the throw-in of bills only are not transmitted to the controller 2.

In the drawings, further, reference numeral 3 denotes communication means for receiving and transmitting the data related to the throw-in of coins. The communication means 3 is electrically connected to the device 1 for identifying the bills through another communication circuit, and is further electrically connected to the controller 2 through a communication circuit. Communication between the communication means 3 and the controller 2 is dependent upon the VTS system. However, the communication means 3 is not the one for executing the payment or defrayal of coins. In the drawings, reference numerals 5, 5 denote 8-pin connectors of the VTS, and 5a denotes a 4-pin connector.

According to the first embodiment, even when the device 1 for identifying the bills is imposing limitation on the maximum amount of money that can be paid, e.g., limiting the maximum amount of money that can be paid to be one dollar, the communication means 3 permits the bills to be thrown in up to a maximum amount of money that can be paid by 25-cent coins. That is, referring to FIG. 2, upon confirming the throw-in of N dollars of bills, the program in the device 1 for identifying the bills transmits the data of throw-in to the communication means 3.

Upon receipt of the data of throw-in of N dollars of bills, the communication means 3 transmits to the controller 2 the data stating that N dollars (cents) are thrown in as coins. Once a dollar of bill is thrown in, it is not usually allowed to additionally throw in the bills. According to this embodiment, however, it is made possible to continuously throw in the bills. That is, when it is attempted to purchase a plurality of goods, a required number of pieces of bills can be thrown in using the VTS system even if the unit price of the good is one dollar without the need of throwing in the bill and depressing the purchase button many time times.

### Embodiment 2

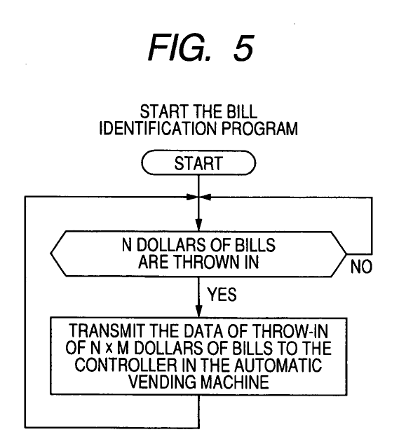

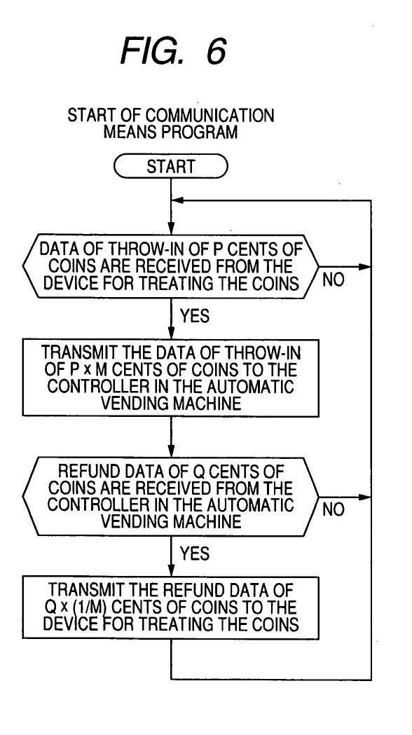

Next, a second embodiment of the invention will be described with reference to FIGS. 4 to 6. FIG. 4 is a block diagram illustrating the second embodiment of the invention, FIG. 5 is a flowchart illustrating a program of the device for identifying the bills, and FIG. 6 is a flowchart illustrating a program of communication means. Portions common to those of the first embodiment are denoted by the same reference numerals, but their detailed description is not repeated.

In the case of the second embodiment, too, the device 1 for identifying the bills is electrically connected to the controller 2 of the automatic vending machine based on the VTS system by using a communication circuit. The communication means 3 is electrically connected to the controller 2 also based on the VTS system but using another communication circuit.

In the second embodiment, the communication means 3 is not connected to the device 1 for identifying the bills through the communication circuit. Instead, a device 4 for treating the coins is electrically connected to the communication means 3 based on the VTS system using a communication circuit.

According to the second embodiment, the data related the throw-in of coins into the device 4 for treating the coins are operated through the communication means 3, and are transmitted to the controller 2 as the throw-in of the amount of M times. The data for refunding the money from the controller 2 are also operated through the communication means 3, and are transmitted to the device for treating the coins as the amount of money of 1/M. Here, M stands for a magnification in calculating the amount of money.

When the minimum amount of money to be thrown into the device 1 for identifying the bills has been set to be, for example, ten dollars in the second embodiment, if a bill worth one dollar is thrown into the device 1 for identifying the bills, the data of throw-in of M times (e.g., 10 times) are transmitted to the controller 2 (see FIG. 5). As for treating the coins, further, if the communication means 3 receives such data that P cents of coins are thrown into the device 4 for treating the coins, the data of thrown-in of M times (e.g., 10 times) of P are transmitted to the controller 2. If the communication means 3 receives the refund data of Q cents of coins from the controller 2, the refund data of 1/M of Q are transmitted to the device 4 for treating the coins (see FIG. 6).

Even when the system is imposing limitation on the minimum amount of money of the bill that can be thrown in, the automatic vending machine can be utilized highly efficiently, and the refund and the treatment of change can be executed without problem.

### Embodiment 3

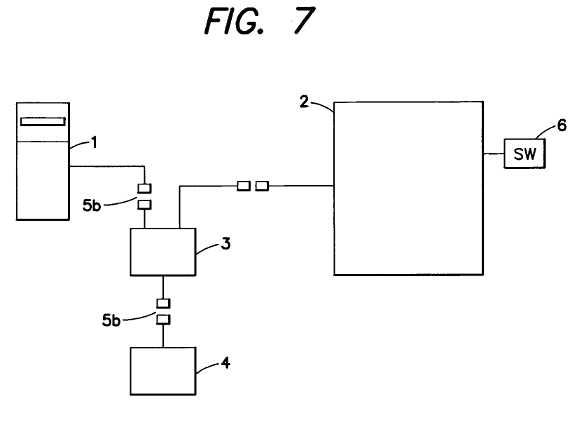

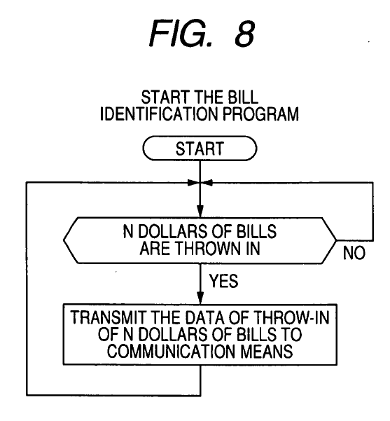

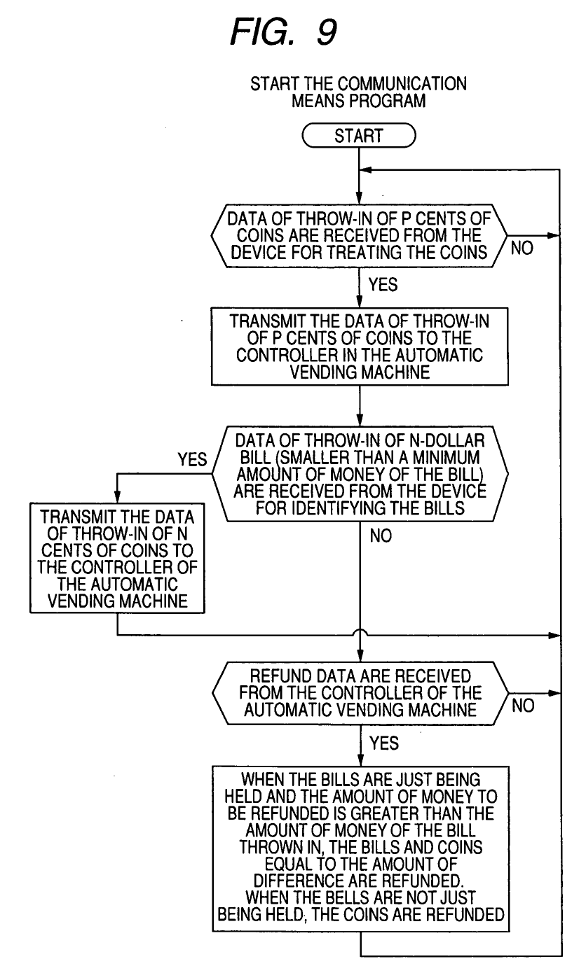

Next, a third embodiment of the invention will be described with reference to FIGS. 7 to 9. FIG. 7 is a block diagram illustrating the third embodiment of the invention, FIG. 8 is a flowchart illustrating a program of the device for identifying the bills, and FIG. 9 is a flowchart illustrating a program of communication means. Portions common to those of the first embodiment and the second embodiment are denoted by the same reference numerals, but their detailed description is not repeated.

According to the third embodiment, communication means 3 is interposed as a communication circuit of the VTS system between the device 1 for identifying the bills and the controller 2, and the device 4 for treating the coins is connected to the communication means through a communication circuit of the MDB system. In the drawing, reference numeral 5b denotes 8-pin connectors of the MDB. That is, the device 4 for treating the coins and the device 1 for treating the bills are both connected to the controller 2 through the communication means 3.

While the device 1 for identifying the bills is imposing limitation on the minimum amount of money that is to be thrown in according to the third embodiment, if a bill which is not smaller than the minimum amount of money is thrown in, the data are directly transmitted to the controller 2 through the communication means 3. Here, if a bill of the amount of money smaller than the above-minimum amount of money is thrown into the device 1 for identifying the bills, the amount of money that is thrown in is converted through the communication means 3 into the data of coins thrown into the device for treating the coins, and is transmitted to the controller 2.

The data of coins thrown into the device 4 for treating the coins are transmitted as ordinary data to the controller 2 through the communication means 3. The communication system may be the one which sets the VTS system and the MDB system in a multiplicity of ways.

According to the third embodiment as shown in FIG. 8, if N dollars of bills are thrown into the device 1 for identifying the bills, the data thereof are transmitted to the communication means 3. Referring to the communication means 3, if coins are thrown into the device 4 for treating the coins as shown in FIG. 9, the data thereof are transmitted to the controller 2. Further, if the data related to the throw-in of a bill smaller than the minimum amount of money are received from the device 1 for identifying the bills, the data are transmitted to the controller 2 stating that the above amount of money is thrown in as coins.

Further, in case the refund data are received from the controller 2, if the bills remain just being held in the device 1 for identifying the bills and the amount of money to be refunded is larger than the amount of money of the bill that is thrown in, coins equal to the difference from the bill are refunded. If no bill is being held, the coins are refunded. Further, if the amount of money to be refunded is smaller than the amount of money of the bill that is thrown in, the bill is pulled in, and the coins are refunded.

In the case of the third embodiment, further, the controller 2 is provided with a change-over switch 6 which can be operated from the outer side. By operating the change-over switch 6, it is allowed to freely change and set the kind of money that can be used in the controller 2, the number of pieces thereof, and a combination thereof, as well as to change the price of the good. Besides, change can be discharged within a range set by the device 4 for treating the coins.

Being constituted as described above, the present invention can be extensively applied not only to the automatic vending machines but also to the systems for treating the money imposing limitation on the bills that are to be thrown in, such as various vending machines of game media. Further, the communication system is not limited to the VTS system or the MDB system, but any other system can be used.

What is claimed is:

1. A system for treating money in an automatic vending machine wherein a device for identifying the bills that are thrown in is electrically connected to a controller in the automatic vending machine, the device for identifying the bills is electrically connected to communication means which receives and transmits the data related to the throw-in of coins, and the communication means is electrically connected to the controller in the automatic vending machine.

2. A system for treating money in an automatic vending machine wherein a device for identifying the bills that are thrown in is electrically connected to a controller in the automatic vending machine, a device for treating the coins that are thrown in is electrically connected to communication means which receives and transmits data related to the throw-in of coins, and the communication means is electrically connected to the controller in the automatic vending machine.

3. A system for treating money in an automatic vending machine wherein a device for treating the coins that are thrown in is electrically connected to communication means which receives and transmits data related to the throw-in of coins, and the communication means, the device for identifying the bills that are thrown in and the controller in the automatic vending machine are electrically connected together.

4. A system for treating money in an automatic vending machine according to claim 3, wherein the primary side and the secondary side of the communication means select either a VTS (vivid transaction system) system or the MDB (multi-drop bus) system and, particularly, the primary side is of the VTS system and the secondary side is of the MDB system.

5. A system for treating money in an automatic vending machine according to claim 3 or 4, wherein the controller is equipped with a change-over switch for changing the price of a good to be sold and for freely setting the kinds of bills that can be used, the number of pieces thereof and a combination thereof, and a change is discharged within a range set by the device for treating the coins.
